(19) United States
(12) Patent Application Publication
(10) Pub. No.: US 2019/0245193 A1
(43) Pub. Date: Aug. 8, 2019

(54) RECHARGEABLE BATTERY

(71) Applicant: Samsung SDI Co., Ltd., Yongin si, Gyeonggi-do (KR)

(72) Inventor: Jindoo KIM, Yongin-si (KR)

(21) Appl. No.: 16/342,518

(22) PCT Filed: Oct. 16, 2017
(86) PCT No.: PCT/KR2017/011407

§ 371 Date: Apr. 16, 2019

(30) Foreign Application Priority Data
Oct. 26, 2016 (KR) 10-2016-0140420

(51) Int. Cl. H01M 2/34; H01M 2/26; H01M 10/48

(52) U.S. Cl. CPC H01M 2/348; H01M 2220/30; H01M 10/486; H01M 2/26

(57) ABSTRACT

A rechargeable battery according to an exemplary embodiment of the present invention includes: a battery assembly having a first electrode and a second electrode; a case receiving the battery assembly; a first lead tab electrically connected to the first electrode; a resistor element electrically connected to the first lead tab; and a second lead tab electrically connected to the resistor element, wherein one of the first lead tab and the second lead tab is electrically connected to the resistor element and includes a first portion having a first width and a second portion connected to the first portion and having a second width that is wider than the first width.

### TECHNICAL FIELD

The present invention relates to a rechargeable battery, and in detail, relates to a rechargeable battery including a resistor element.

### BACKGROUND ART

With the development of mobile devices, demand for rechargeable batteries as an energy source has increased. In addition, high-energy, down-sized, light, and slim mobile devices have been required. For example, a rechargeable battery is flatly formed using a polymer solid electrolyte film. As the rechargeable battery, there is a pouch-type battery effectively implementing the slimness of the battery.

In a lithium ion polymer rechargeable battery, an electrode assembly is formed by stacking a positive electrode and a negative electrode at respective sides of a polymer solid electrolyte film for passing lithium ions therebetween, and a pouch is formed by thermally fusion-bonding a peripheral portion of a casing material by disposing the casing material at both surfaces of the electrode assembly, thereby being formed in a structure of housing the electrode assembly in the pouch.

A positive electrode lead tab connected to the positive electrode of the electrode assembly and a negative electrode lead tab connected to the negative electrode are drawn out to one side of the pouch. The positive electrode lead tab and the negative electrode lead tab are electrically connected to a protection circuit module (PCM) that includes protection circuit parts.

The protective circuit module prevents an overcharge, an over-discharge, an overcurrent, and a short of the rechargeable battery. In addition, a resistor element having a positive temperature coefficient is used between the protective circuit module and the positive electrode lead tab.

When the temperature of the rechargeable battery reaches a predetermined risk value, the resistor element electrically isolates the positive terminal from the protective circuit module, and when the temperature of the rechargeable battery reaches the setup safety value, the resistor element again connects the positive terminal to the protective circuit module. Therefore, a need exists for a resistor element having excellent temperature detecting performance for the rechargeable battery.

### DISCLOSURE

### Technical Problem

One aspect of the present invention is to provide a rechargeable battery capable of preventing an explosion due to overheating of the rechargeable battery by quickly operating a resistor element when the rechargeable battery generates heat.

### Technical Solution

A rechargeable battery according to an exemplary embodiment of the present invention includes: a battery assembly including a first electrode and a second electrode; a case receiving the battery assembly; a first lead tab electrically connected to the first electrode; a resistor element electrically connected to the first lead tab; and a second lead tab electrically connected to the resistor element, wherein one of the first lead tab and the second lead tab is electrically connected to the resistor element, and includes a first portion having a first width and a second portion connected to the first portion and having a second width that is wider than the first width.

The resistor element may include a first connection portion connected to the first lead tab and a second connection portion electrically connected to the second lead tab.

The first portion of the second lead tab and the second connection portion may be connected by a plurality of spot welds.

A connection member overlapping the first portion of the second lead tab and the second connection portion may be further included, and the second connection portion and the first portion of the second lead tab may be coupled to the connection member with a plurality of spot welds.

A third lead tab electrically connected to the second electrode may be further included.

The resistor element may include a positive temperature coefficient element of which a resistance increases infinitely at a predetermined temperature.

The case may be a pouch.

A rechargeable battery according to another exemplary embodiment of the present invention includes: a battery assembly including a first electrode and a second electrode; a case receiving the battery assembly; a first lead tab electrically connected to the first electrode and having a first sub-lead portion and a second sub-lead portion; a second lead tab connected to the second electrode; a resistor element having a first connection portion and a second connection portion connected to the first sub-lead portion and the second sub-lead portion, respectively; and an auxiliary heating portion connecting between the first sub-lead portion and the first connection portion or between the second sub-lead portion and the second connection portion.

The auxiliary heating portion may include a plurality of spot welds.

The second sub-lead portion may have a first portion having a first width and a second portion having a width that is wider than the first width, and the first portion may be connected to the auxiliary heating portion.

The spot welds may be formed by friction welding or resistive welding.

The resistor element may include a positive temperature coefficient element of which a resistance increases infinitely at a predetermined temperature.

The case may be a pouch.

According to an exemplary embodiment of the present invention, when the auxiliary heating portion is formed, the current blocking ability of the resistor element may be improved, thereby minimizing the chance of battery explosion due to overheating of the battery assembly.

### Advantageous Effects

### DESCRIPTION OF THE DRAWINGS

FIG. 1 is a perspective view of a rechargeable battery according to an exemplary embodiment of the present invention.

FIG. 2 is a perspective view in which an electrode assembly and a pouch of a rechargeable battery shown in FIG. 1 are disassembled.

FIG. 3 is an enlarged top plan view of a portion of FIG. 1.

FIG. 4 is a schematic cross-sectional view of a resistor element according to an exemplary embodiment of the present invention.

FIG. 5 is a perspective view of a rechargeable battery according to another exemplary embodiment of the present invention.

FIG. 6 is an enlarged top plan view of a portion of FIG. 5.

FIG. 7 is a graph illustrating a temperature change depending on time of a rechargeable battery according to a conventional art.

FIG. 8 is a graph illustrating a temperature change depending on time of a rechargeable battery according to an exemplary embodiment of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the scope of the present invention.

The drawings and description are to be regarded as illustrative in nature and not restrictive. Like reference numerals designate like elements throughout the specification.

Further, in the drawings, a size and thickness of each element are arbitrarily represented for better understanding and ease of description, and the present invention is not limited thereto.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Hereinafter, a rechargeable battery according to an exemplary embodiment of the present invention is described in detail with reference to accompanying drawings.

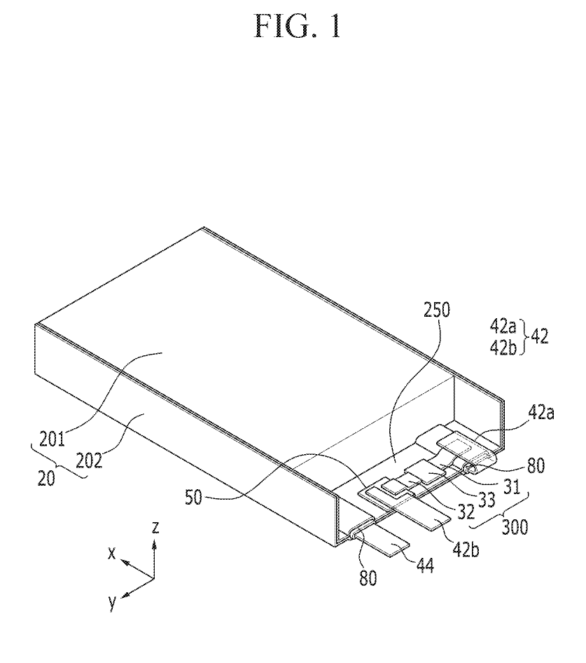

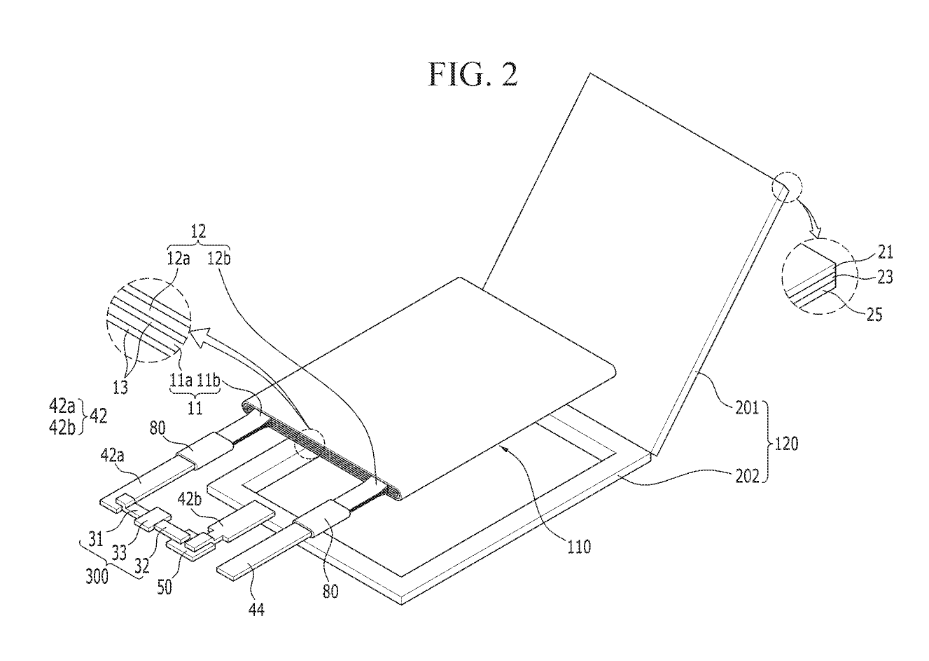

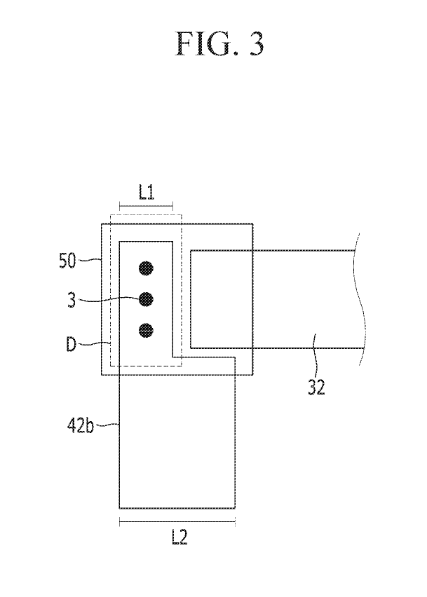

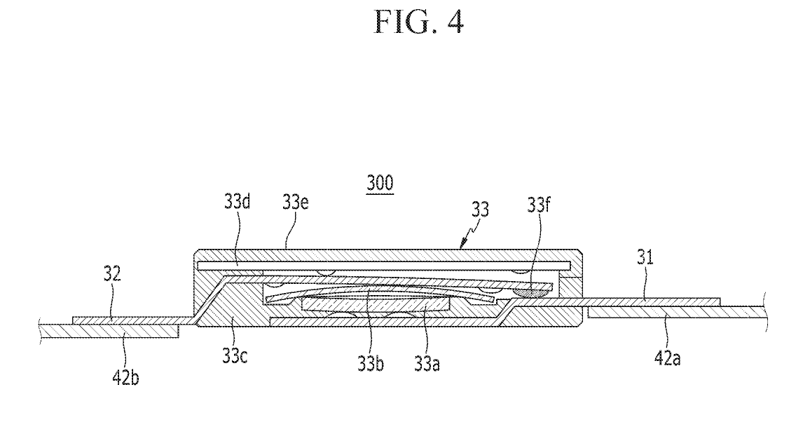

FIG. 1 is a perspective view of a rechargeable battery according to an exemplary embodiment of the present invention, FIG. 2 is a perspective view in which an electrode assembly and a pouch of a rechargeable battery shown in FIG. 1 are disassembled, FIG. 3 is an enlarged top plan view of a portion of FIG. 1, and FIG. 4 is a schematic cross-sectional view of a resistor element according to an exemplary embodiment of the present invention.

As shown in FIG. 1 to FIG. 3, a rechargeable battery according to an exemplary embodiment of the present invention includes an electrode assembly 110 and a case receiving the electrode assembly 110. The case may be a square or pouch type, and the pouch type 120 is described below as an example.

The electrode assembly 110 includes a first electrode 11, a second electrode 12, and a separator 13 disposed between the first electrode and the second electrode. The separator 13 is for insulation, and they may be stacked in the order of the first electrode 11, the separator 13, the second electrode 12, and the separator 13.

The electrode assembly 110 may have a jelly-roll shape in which the first electrode 11, the separator 13, and the second electrode 12 are spirally wound about a winding axis in a laminated state. If desired, the electrode assembly may be spirally wound and then flat-pressed, and a cross-section thereof may be approximately elliptical.

Alternatively, the electrode assembly 110 may have a substantially rectangular cross-section, in which the first electrode 11, the separator 13, and the second electrode 12 in the form of sheets are repeatedly stacked (not shown).

The first electrode 11 and the second electrode 12 respectively include a first electrode active region 11a and a second electrode active region 12a in which an active material is coated on a thin plate formed of a metal foil with a belt shape, and a first electrode uncoated region 11b and a second electrode uncoated region 12b in which the active material is not coated, respectively. The first electrode uncoated region 11b and the second electrode uncoated region 12b may be formed every predetermined interval along one side of the first electrode active region 11a and the second electrode active region 12a, respectively, and wound around a winding axis such that a plurality of first electrode uncoated regions 11b may be overlapped and a plurality of second electrode uncoated regions 12b may be overlapped.

The plurality of first electrode uncoated regions 11b may be welded to each other by ultrasonic welding, etc., and the plurality of second electrode uncoated regions 12b may be welded to each other by ultrasonic welding, etc.

The first electrode uncoated region 11b and the second electrode uncoated region 12b may be disposed to be separated by a predetermined interval, so as to not be short-circuited. For example, the first electrode 11 may be a positive electrode of the rechargeable battery, and the first electrode active region 11a may be coated with the active material such as a transition metal oxide on a metal foil such as aluminum. The second electrode 12 may be a negative electrode of the rechargeable battery, and the second electrode active region 12a may be coated with the active material such as graphite or carbon on a metal foil such as copper or nickel.

The separator 13 is made of a porous material, and may be made of polyolefin, polyethylene, polypropylene, or the like.

The electrode assembly 110 may be sealed in after being inserted into the pouch together with the electrolyte. The electrolyte solution may be made of a lithium salt such as LiPF₆ and LiBF₄ in an organic solvent such as EC, PC, DEC, EMC, and EMC. The electrolyte solution may be a liquid, solid, or gel.

The pouch 120 includes a lower sheet 201 and an upper sheet 202 formed in a multi-layered sheet structure. For example, the upper sheet 202 and the lower sheet 201 of the pouch include a polymer sheet 21 forming an inner surface and performing insulation and thermal fusion-bonding functions, a polyethylene terephthalate (PET) sheet, a nylon sheet, or a PET-nylon complex sheet 25 forming an outer surface and performing a protection function, and a metal sheet 23 providing mechanical strength. The metal sheet may be, for example, an aluminum sheet, and is disposed between an adhesive sheet and the nylon sheet.

The upper sheet 202 or the lower sheet 201 may be formed as a concave structure to receive the electrode assembly 110.

After receiving the electrode assembly 110, the pouch 120 is sealed while a terrace portion 250 is formed by thermally fusing the edge portions of the upper sheet and the lower sheet disposed around the electrode assembly 110 to each other.

The first electrode uncoated region 11b and the second electrode uncoated region 12b may be electrically connected to a first lead tab 42 and a second lead tab 44, respectively. The first lead tab 42 and the second lead tab 44 are connected to the outside of the thermally-fused pouch 120 such that the electrode assembly 110 is electrically drawn outside the pouch 120.

That is, the first lead tab 42 and the second lead tab 44 are disposed to penetrate the edge portion of the thermally-fused upper sheet and lower sheet at the terrace portion 250 formed on one side (the y-z plane of FIG. 1) of the pouch 120. At this time, the first lead tab 42 and the second lead tab 44 may be sealed more tightly with the pouch 120 by insulating members 80, respectively.

The terrace portion 250 may be formed by thermally fusing the edge of the upper sheet 202 bent along the electrode assembly 110 to the flat edge of the lower sheet 201 at the draw-out side of the first lead tab 42 and the second lead tab 44.

The rechargeable battery may include a protective circuit module (not shown) formed by mounting protective circuit elements on a circuit substrate to be protected from an overcharge, an over-discharge, an overcurrent, and an external short.

The second lead tab 44 may be directly connected to the protective circuit module (not shown), and the first lead tab 42 may be connected to the protective circuit module via a resistor element 300. Thus, the first lead tab 42 includes a first sub-lead portion 42a and a second sub-lead portion 42b that are separated on both sides based on the resistor element 300.

Referring to FIG. 4, the resistor element 300 includes a positive temperature coefficient (hereinafter, PTC) element 33a of which a resistance is increased to infinity at a predetermined temperature. The positive temperature coefficient element 33a is in contact with the first connection portion 31 in a transmitting portion 33, and a bimetal disc 33b is in contact with the upper surface of the PTC element 33a in the transmitting portion 33. A second connection portion 32 is in contact with the first connection portion 31 at a contact point 33f and the second connection portion 32 is also in contact with the bimetal disc 33b. The first connection portion 31 extends into the transmitting portion 33 and is partially exposed toward the lower surface. Thus, the first connection portion 31 and the second connection portion 32 are electrically connected to each other.

Heat generated in the pouch may be transmitted to the PTC element 33a of the resistor element through the first sub-lead portion 42a of the first lead tab 42 or directly from the pouch. When the heat is transferred to the PTC element 33a of the resistor element 300, the PTC element 33a is heated to invert the bimetal disc 33b.

When the inverted bimetal disc 33b pushes the second connection portion 32 toward the upper surface of the transmitting portion 33, that is, a cover plate 33d, the first connection portion 31 and the second connection portion 32 are separated from each other and resultantly are electrically cut off. At this time, the temperature at which the PTC element is heated and the electrical disconnection occurs due to the resistor element may be set as a temperature below a temperature at which the pouch explosion occurs.

Again referring to FIG. 1 to FIG. 3, while the width of the first sub-lead portion 42a of the first lead tab 42 is constantly formed, the second sub-lead portion 42b includes a first portion having a first width and a second portion having a second width L2. At this time, the second width L2 may be larger than the first width L1. The first sub-lead portion 42a may be connected to the first connection portion 31 of the resistor element 300, and the second sub-lead portion 42b may be connected to the second connection portion 32 of the resistor element 300 through a connection member 50. The second sub-lead portion 42b is coupled to the connection member 50 at the first portion having the first width L1.

One surface of the second connection portion 32 and one surface of the connection member 50 are in contact with each other and may be coupled together by welding, and one surface of the second sub-lead portion 42b and one surface of the connection member 50 are in contact with each other and may be coupled together by welding. At this time, the area (referred to as a first welding portion) where the second connection portion 32 and the connection member 50 are welded may be most of the area where the second connection portion 32 and the connection member 50 are overlapped. The area (hereinafter referred to as a second welding portion) where the second sub-lead portion 42b and the connection member 50 are welded may be welded to the portion among the area where the second sub-lead portion 42b and the connection member 50 are overlapped. The second welding portion may be formed by spot welding, and a plurality of spot welds 3 may be formed in the region where the second portion 42b and the connection member 50 are overlapped.

The plurality of spot welds 3 may be formed with the same size and at regular intervals, but are not limited thereto and may be formed in various sizes and intervals as required.

The second sub-lead portion 42b of the first lead tab and the plurality of spot welds 3 form an auxiliary heating portion D, and heat may be generated in the auxiliary heating portion D due to a bottleneck of the current.

Thus, the width of the first portion is formed with the length such that heat may be generated by the heat bottleneck phenomenon, and the length may be controlled according to an amount of heat required, however the width of the first portion is not limited thereto and the first portion may be formed with various shapes to obtain the required heat. For example, by reducing the thickness of the first portion of the current path, which is disposed on a path where the current moves, it is possible to generate heat by reducing the cross-section of the path through which the current moves, or to induce the bottleneck phenomenon and heat by using a material of which resistance is relatively high.

Also, as the number and size of the spot welds increases, the amount of heat generated may be reduced, so that the spot welds may be formed in various numbers and sizes according to the required amount of heat.

As described above, like the exemplary embodiment of the present invention, as the width of the second sub-lead portion 42b connected to the resistor element 300 is formed differently and the auxiliary heating portion D is formed by spot-welding the portion having the relatively narrow first width L1, a current blocking capability of the resistor element 300 may be improved.

For example, if the battery assembly is overheated due to an abnormal reaction, the resulting heat is transferred to the resistor element 300. At this time, the battery assembly is disposed in the pouch and the resistor element 300 is disposed outside the pouch 120, so that there may be a difference between the temperature inside the pouch 120 and the predetermined temperature so as to block the current by the resistor element 300. Due to this temperature difference, the temperature inside the pouch 120 continues to rise before the resistor element 300 reaches the current blocking temperature, allowing the battery to explode before the resistor element 300 disconnects the current.

In an exemplary embodiment of the present invention, however, as the difference between the temperature inside the pouch and the temperature at which the resistor element blocks the current are reduced, the current is disconnected before the battery explodes to prevent the battery explosion. That is, in an exemplary embodiment of the present invention, the auxiliary heating portion D is used to further heat the resistor element so that the difference between the temperature inside the pouch and the temperature at which the resistor element blocks the current is reduced, thereby the resistor element is operated before the battery explodes.

The second sub-lead portion 42b of the auxiliary heating portion D is relatively narrower in width than the other portion, resulting in the bottleneck phenomenon of a current, which is transferred to the adjacent resistor element. At this time, the heat transferred to the resistor element does not heat the PTC element until the temperature at which the resistor element blocks current. Therefore, when there is no heat transmitted from the inside of the pouch, the phenomenon that the resistor element blocks the current by the heat generated in the auxiliary heating portion D does not occur.

On the other hand, when the abnormal reaction occurs inside the pouch, the heat is generated and the heat inside the pouch is transferred to the resistor element along with the heat transmitted from the auxiliary heating portion D, so that the temperature rapidly rises to the temperature at which the resistor element interrupts the current.

That is, as the heat due to the auxiliary heating portion D is further transmitted, the resistor element blocks the current before the battery is exploded, thereby preventing the battery from exploding. Therefore, it is desirable for the auxiliary heating portion D to generate the heat that may raise the temperature of the resistor element by more than the difference between the temperature inside the pouch and the temperature of the resistor element.

For example, when using the resistor element that is predetermined to block the current at 77° C., the temperature inside the pouch must be at least about 85° C. so that the resistor element outside the pouch may block the current. At this time, since the temperature difference between the inside and the outside of the pouch is about 8° C., it is desirable for the auxiliary heating portion to generate the heat that may raise the temperature of the resistor element by about 8° C. or more.

As described above, like an exemplary embodiment of the present invention, the heat may be easily induced according to the characteristics of the battery assembly and the resistor element, thereby improving the current blocking ability of the resistor element.

In the above exemplary embodiment, the auxiliary heating portion is connected to the second connection portion, however, the present invention is not limited thereto, and it may be connected to the first connection portion if the heat is generated.

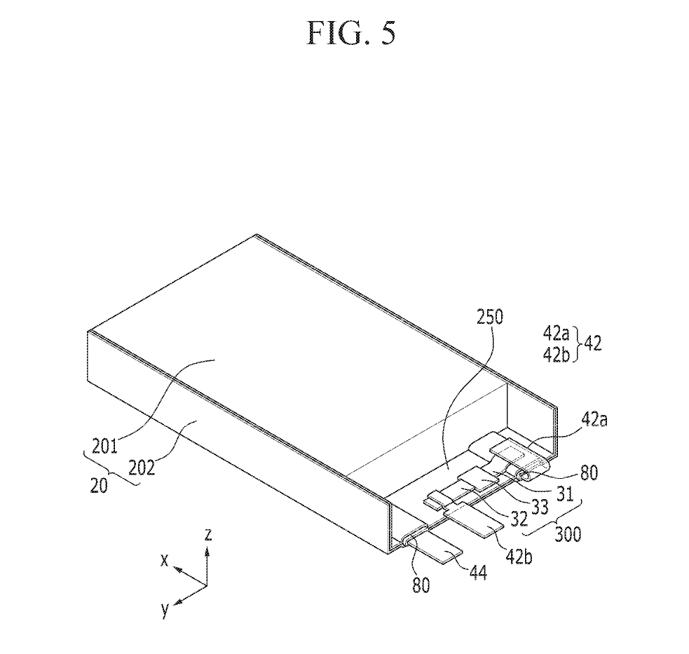

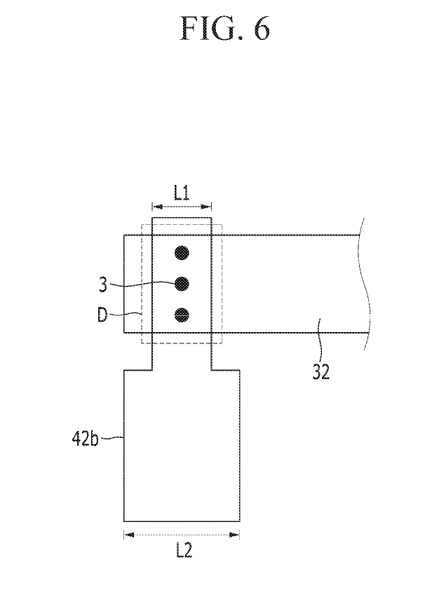

FIG. 5 is a perspective view of a rechargeable battery according to another exemplary embodiment of the present invention, and FIG. 6 is an enlarged top plan view of a portion of FIG. 5.

The rechargeable battery of FIG. 5 and FIG. 6 is the same as most of the rechargeable battery of FIG. 1 to FIG. 4, such that only other portions are described in detail.

The rechargeable battery of FIG. 5 and FIG. 6 includes the electrode assembly and the pouch 120 type of case receiving the electrode assembly. The first electrode uncoated region of the electrode assembly is connected to the first lead tab 42 and the resistor element 300, and the second electrode uncoated region is connected to the second lead tab 44.

The first lead tab 42 and the second lead tab 44 may be installed through the terrace portion 250 of the pouch 120, and the resistor element 300 may be disposed above the terrace portion 250.

The first lead tab 42 includes the first sub-lead portion 42a and the second sub-lead portion 42b which are connected to the first connection portion 31 and the second connection portion 32 via the resistor element 300, respectively.

The second sub-lead portion 42b has the first portion having the first width L1 and the second portion having a second width L1, and the second width L2 may be formed wider than the first width L1.

The first portion having the first width L1 may be electrically connected to the second sub-lead portion 42b through the auxiliary heating portion, and the auxiliary heating portion may include a plurality of spot welds.

The first width is formed with the length such that heat may be generated by the heat bottleneck phenomenon, and the length may be controlled according to an amount of heat required, however the width of the first portion is not limited thereto and the first portion may be formed with various shapes to obtain the required heat. For example, by reducing the thickness of the first portion of the current path, which is disposed on a path where the current moves, it is possible to generate heat by reducing the cross-section of the path through which the current moves, or to induce the bottleneck phenomenon and heat by using the material of which the resistance is relatively high.

Also, as the number and size of the spot welds increases, the amount of heat generated may be reduced, so that the spot welds may be formed in various numbers and sizes according to the required amount of heat.

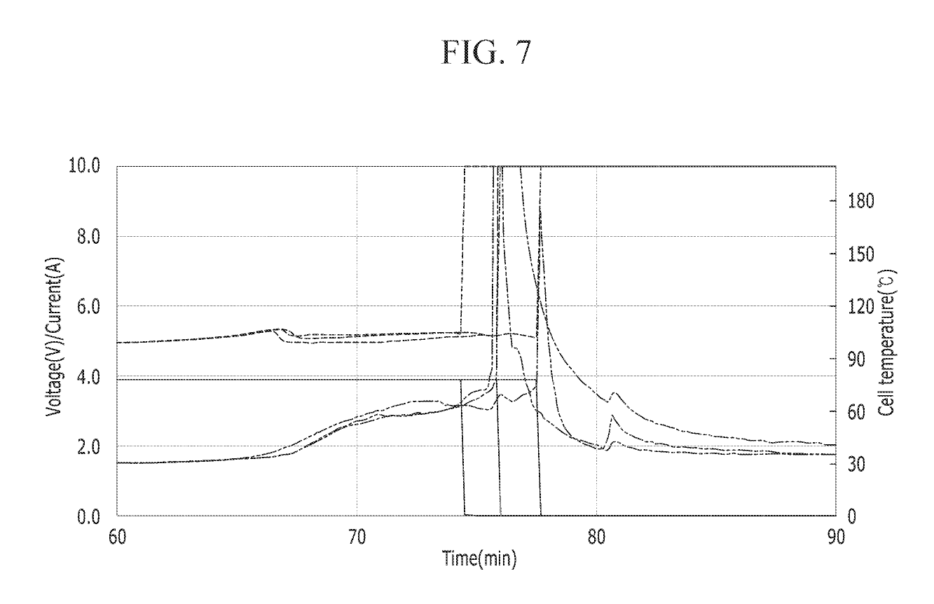

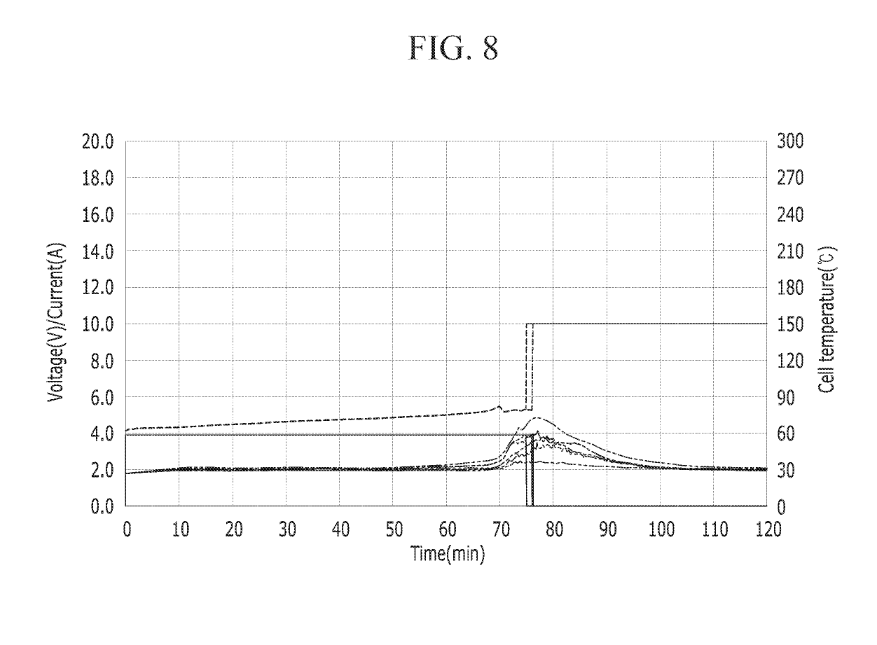

FIG. 7 is a graph measuring a temperature change depending on time of a rechargeable battery according to a conventional art, and FIG. 8 is a graph measuring a temperature change depending on time of a rechargeable battery according to an exemplary embodiment of the present invention.

Referring to FIG. 7, it may be confirmed that the temperature of the pouch when the current is blocked in the rechargeable battery according to the conventional art is about 80° C.

Also, referring to FIG. 8, it may be confirmed that the temperature of the pouch when the current is blocked in the rechargeable battery according to the present invention is about 60° C., which indicates that the current is blocked at an even temperature lower than the conventional art.

While this invention has been described in connection with what is presently considered to be practical exemplary embodiments, it is to be understood that the invention is not limited to the disclosed embodiments. On the contrary, it is intended to cover various modifications and equivalent arrangements included within the scope of the appended claims.

### DESCRIPTION OF SYMBOLS

| | |
|---|---|
| 3: spot welds | |
| 11: first electrode | 12: second electrode |
| 11a: first electrode active region | 12a: second electrode active region |
| 11b: first electrode uncoated | 12b: second electrode uncoated |
| region | region |
| 13: separator | 31: first connection portion |
| 21: polymer sheet | 23: metal sheet |
| 25: complex sheet | 32: second connection portion |
| 33: transmitting portion | 33a: PTC element |
| 42: first lead tab | 42a: first portion |
| 42b: second portion | 44: second lead tab |
| 50: connection member | 80: insulating member |
| 110: electrode assembly | 120: pouch |
| 201: lower sheet | 202: upper sheet |
| 250: terrace portion | 300: resistor element |

1. A rechargeable battery comprising:
a battery assembly having a first electrode and a second electrode;
a case receiving the battery assembly;
a first lead tab electrically connected to the first electrode;
a resistor element electrically connected to the first lead tab; and
a second lead tab electrically connected to the resistor element,
wherein one of the first lead tab and the second lead tab is electrically connected to the resistor element and includes a first portion having a first width and a second portion connected to the first portion and having a second width that is wider than the first width.

2. The rechargeable battery of claim 1, wherein
the resistor element includes a first connection portion connected to the first lead tab and a second connection portion electrically connected to the second lead tab.

3. The rechargeable battery of claim 2, wherein
the first portion of the second lead tab and the second connection portion are connected by a plurality of spot welds.

4. The rechargeable battery of claim 2, further comprising:
a connection member overlapping the first portion of the second lead tab and the second connection portion,
wherein the second connection portion and the first portion of the second lead tab are coupled to the connection member with a plurality of spot welds.

5. The rechargeable battery of claim 1, further comprising
a third lead tab electrically connected to the second electrode.

6. The rechargeable battery of claim 1, wherein
the resistor element includes a positive temperature coefficient element of which resistance increases infinitely at a predetermined temperature.

7. The rechargeable battery of claim 1, wherein
the case is a pouch.

8. A rechargeable battery comprising:
a battery assembly having a first electrode and a second electrode;
a case receiving the battery assembly;
a first lead tab electrically connected to the first electrode and having a first sub-lead portion and a second sub-lead portion;
a second lead tab connected to the second electrode;
a resistor element having a first connection portion and a second connection portion connected to the first sub-lead portion and the second sub-lead portion, respectively; and
an auxiliary heating portion connecting between the first sub-lead portion and the first connection portion or between the second sub-lead portion and the second connection portion.

9. The rechargeable battery of claim 8, wherein
the auxiliary heating portion includes a plurality of spot welds.

10. The rechargeable battery of claim 9, wherein
the second sub-lead portion has a first portion having a first width and a second portion having a wider width than the first width, and
the first portion is connected to the auxiliary heating portion.

11. The rechargeable battery of claim 9, wherein
the spot welds are formed by friction welding or resistive welding.

12. The rechargeable battery of claim 8, wherein
the resistor element includes a positive temperature coefficient element of which resistance increases infinitely at a predetermined temperature.

13. The rechargeable battery of claim 8, wherein
the case is a pouch.
